(19) United States
(12) Patent Application Publication
(10) Pub. No.: US 2010/0017964 A1
(43) Pub. Date: Jan. 28, 2010

(54) PATIENT BED

(76) Inventor: Ronald J. Kruse, Cincinnati, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 12/177,920

(22) Filed: Jul. 23, 2008

(51) Int. Cl. A61G 7/02; A61G 7/015; A61G 7/018

(52) U.S. Cl. 5/604; 5/613; 5/614

(57) ABSTRACT

A reconfigurable bed comprising: (a) a bed chassis; (b) a plurality of bed sections, each bed section including a removable universal bed cushion; (c) a plurality of actuators operatively coupled the plurality of bed sections and operative to reposition at least one of the plurality of bed sections, where at least one of the plurality of bed sections is laterally repositionable with respect to the bed chassis to expose an excrement receiver, and where the laterally repositionable bed section interposes two of the plurality of bed sections, these two bed sections are adapted to be, independently raised, thereby resulting in the laterally repositionable bed section being recessed with respect thereto and allow exposure of the excrement receiver.

### FIELD OF THE INVENTION

The present invention is directed to patient beds and, more specifically, to reconfigurable patient beds.

### INTRODUCTION TO THE INVENTION

It is a first aspect of the present invention to provide a reconfigurable bed comprising: (a) a bed chassis; (b) a first bed section mounted to the bed chassis; (c) a second bed section mounted to the bed chassis; (d) a third bed section mounted to the bed chassis; (e) a fourth bed section mounted to the bed chassis; (f) a first actuator operatively coupled to the first bed section; (g) a second actuator operatively coupled to the bed chassis and operatively coupled to the second bed section; (h) a third actuator operatively coupled to the bed chassis and operatively coupled to the third bed section, where the first bed section, the second bed section, the third bed section, and the fourth bed section are oriented along a single plane to comprise a patient bed.

In a more detailed embodiment of the first aspect, at least one of the first actuator, the second actuator, and the third actuator comprises at least one of a pneumatic actuator, a geared actuator, and a hydraulic actuator. In yet another more detailed embodiment, at least one of the first bed section, the second bed section, and the third bed section include a removable bed cushion, where the removable bed cushion for the first bed section is interchangeable with the removable bed cushion of the second bed section. In a further detailed embodiment, the fourth bed section is repositionable with respect to the first bed section, the second bed section, and the third bed section to selectively expose and cover an opening through the bed chassis. In still a further detailed embodiment, the opening through the bed chassis is defined by a stationary platform upon which the third bed section rides to selectively expose and cover the opening through the bed chassis. In a more detailed embodiment, the third bed section is independently repositionable with respect to the first bed section, the second bed section, and the third bed section in height and tilt.

In yet another more detailed embodiment of the first aspect, the first bed section and the second bed section are mounted to a repositionable frame, and the second actuator is operatively coupled to the repositionable frame to concurrently reposition the first bed section and the second bed section. In still another more detailed embodiment, the first actuator is operatively coupled to the first bed section and operatively coupled to the repositionable frame, and the first actuator is operative to reposition the first bed section independent of the second bed section. In a further detailed embodiment, the bed chassis includes a lateral fold-out stand operative to support the fourth bed section when the fourth bed section exposes the opening through the bed chassis.

It is a second aspect of the present invention to provide a reconfigurable bed comprising: (a) a bed chassis; (b) a plurality of bed sections, each bed section including a removable universal bed cushion; (c) a plurality of actuators operatively coupled the plurality of bed sections and operative to reposition at least one of the plurality of bed sections, where at least one of the plurality of bed sections is laterally repositionable with respect to the bed chassis to expose an excrement receiver, and where the laterally repositionable bed section interposes two of the plurality of bed sections, these two bed sections are adapted to be independently raised, thereby resulting in the laterally repositionable bed section being recessed with respect thereto and allow exposure of the excrement receiver.

In a more detailed embodiment of the second aspect, the plurality of bed sections includes a first bed section, the plurality of actuators includes a first actuator, and the first actuator is operatively coupled to the first bed section and operative to change the tilt angle of the first bed section. In yet another more detailed embodiment, the plurality of bed sections includes a second bed section, the plurality of actuators includes a second actuator, and the second actuator is operatively coupled to the second bed section and the first bed section, the second actuator operative to change the height of the first bed section. In a further detailed embodiment, the plurality of bed sections includes a second bed section, the plurality of actuators includes a second actuator, and the second actuator is operatively coupled to the second bed section and operative to change the tilt angle of the second bed section. In still a further detailed embodiment, at least one of the plurality of actuators comprises at least one of a pneumatic actuator, a geared actuator, and a hydraulic actuator.

In yet another more detailed embodiment of the second aspect, at least three of the plurality of bed sections is operatively coupled to at least one of the plurality of actuators to reposition at least two of the at least three bed sections independently of one another. In still another more detailed embodiment, at least two of the plurality of bed sections are concurrently mounted to a repositionable frame, and at least one of the plurality of actuators is operatively coupled to the repositionable frame in order to concurrently reposition at least the two bed sections. In a further detailed embodiment, the bed chassis includes a lateral fold-out stand operative to support the laterally repositionable bed section when the laterally repositionable bed section exposes of the excrement receiver.

It is a third aspect of the present invention to provide a method of reconfiguring a patient in a bed between a lying position and a seated position, the method comprising: (a) repositioning a first bed cushion and a third bed cushion, wherein a second bed cushion interposes the first bed cushion and the third bed cushion, wherein the first bed cushion and the second bed cushion are tilted so that at least a portion of the cushions are raised above the second bed cushion; and (b) repositioning the second bed cushion to expose an opening of a simulated toilet while the first and third bed cushions are tilted.

In a more detailed embodiment of the third aspect, prior to repositioning the second bed cushion, the first bed cushion, the second bed cushion, and the third bed cushion lie along a single plane, and subsequent to repositioning the second bed cushion, the first bed cushion, the second bed cushion, and the third bed cushion do not lie along the single plane. In yet another more detailed embodiment, the method further includes the step of repositioning a first bed cushion to be approximately perpendicular with respect to a plane of the opening after repositioning the second bed cushion to expose the opening.

### BRIEF DESCRIPTION OF THE DRAWINGS

FIG. 1 is a plan view of components of an exemplary patient bed in accordance with the present invention;

FIG. 2 is a profile view of the exemplary patient bed of FIG. 1 shown in a flat position;

FIG. 3 is a profile view of the exemplary patient bed of FIG. 2, shown with a bed section repositioned in a tilted position;

FIG. 4 is a plan view of components of an exemplary patient bed in accordance with the present invention;

FIG. 5 is a profile view of the exemplary patient bed of FIG. 4 shown in a flat position;

FIG. 6 is a profile view of the exemplary patient bed of FIG. 5, shown with two bed sections repositioned in a raised position;

FIG. 7 is a plan view of components of an exemplary patient bed in accordance with the present invention, shown with a bed section laterally repositioned to expose and excrement receiver opening;

FIG. 8 is an end view of components of an exemplary patient bed in accordance with the present invention, shown with bed sections lying in a flat position;

FIG. 9 is a end view of the exemplary patient bed of FIG. 8, shown with a bed section laterally repositioned and supported by a lateral stand, while another bed section is raised;

FIG. 10 is a plan view of components of an exemplary patient bed in accordance with the present invention;

FIG. 11 is a profile view of the exemplary patient bed of FIG. 10 shown in a flat position;

FIG. 12 is a profile view of the exemplary patient bed of FIG. 11, shown with a bed section repositioned in a raised position;

FIG. 13 is a profile view of the exemplary patient bed of FIG. 11, shown with a bed section repositioned in a lowered position;

FIG. 14 is a profile view of an exemplary patient bed in accordance with the present invention, shown with the cushions lying substantially along the same line and at the same height;

FIG. 15 is a profile view of the exemplary patient bed of FIG. 14, shown with a pair of cushions raised, and one of the cushions tilted;

FIG. 16 is a profile view of the exemplary patient bed of FIG. 14, shown with a pair of cushions raised, a third cushion tilted, and a fourth cushion tilted and lowered;

FIG. 17 is a profile view of the exemplary patient bed of FIG. 14, shown with a one cushion tilted and another/cushion raised;

FIG. 18 is a profile View of the exemplary patient bed of FIG. 14, shown with a one cushion tilted and another cushion raised and horizontally repositioned;

FIG. 19 is a profile view of the exemplary patient bed of FIG. 14, shown with a one cushion slid out from under the patient and replaced with a toilet seat, while another cushion is shown raised and horizontally repositioned; and

FIG. 20 is a profile view of the exemplary patient bed of FIG. 19, shown with a cushions and toilet seat in an excrement receiver position.

### DETAILED DESCRIPTION

The exemplary embodiments are described and illustrated below are directed to reconfigurable patient beds, as well as methods of reconfiguring a patient bed. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

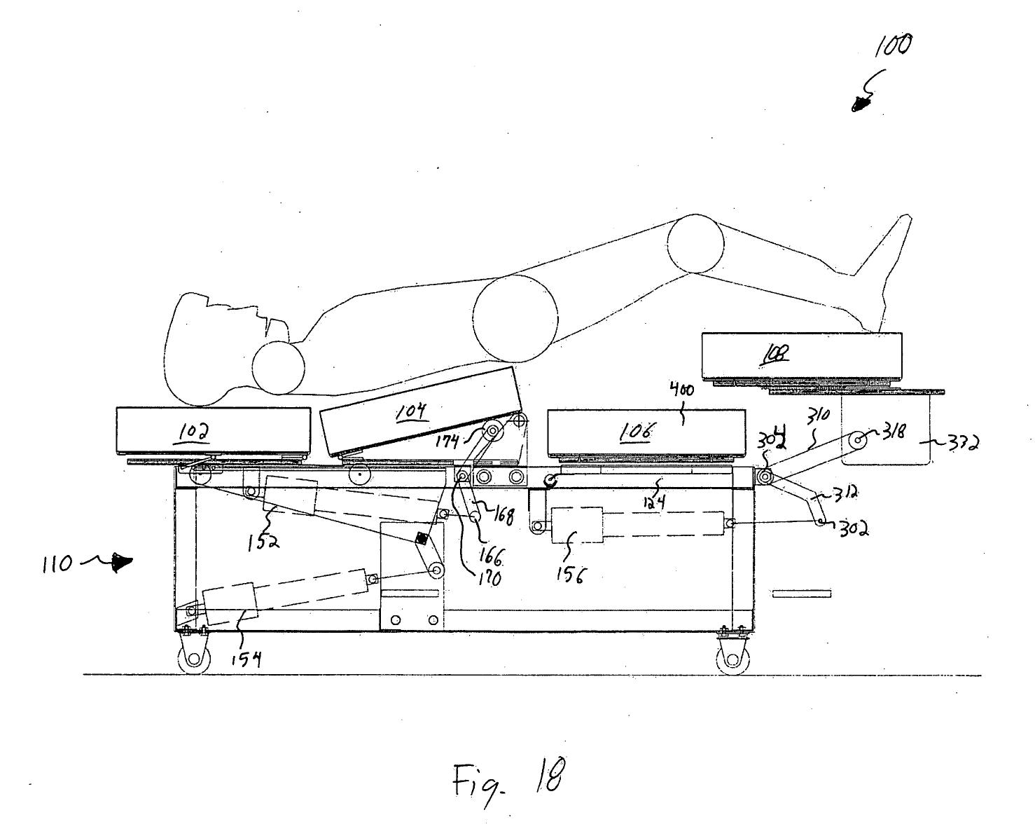

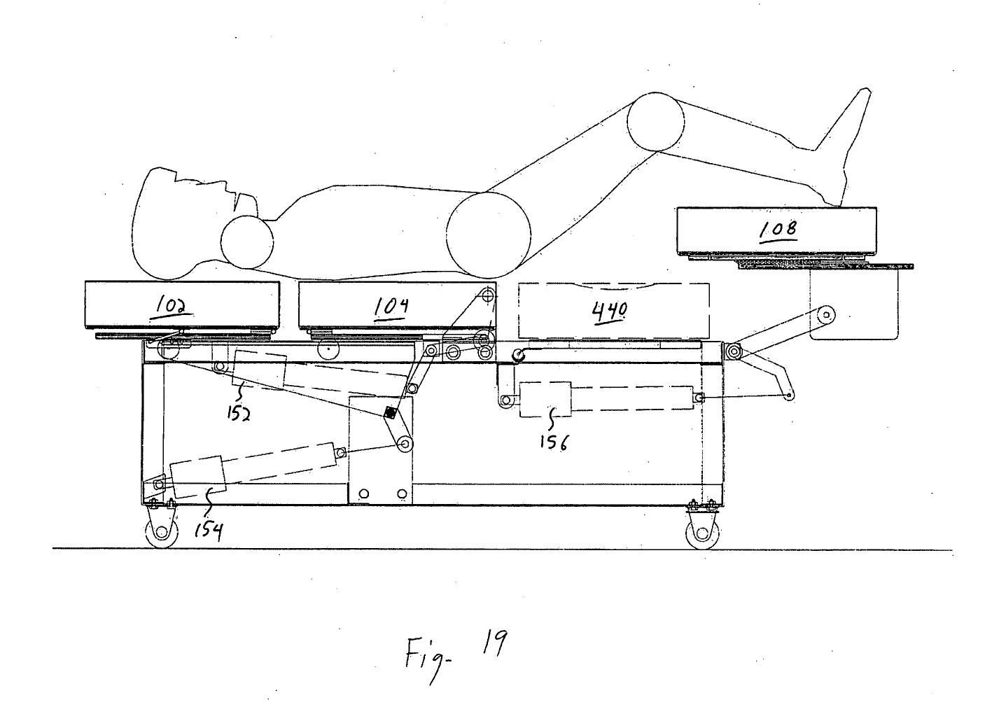

Referencing FIGS. 1-3 and 14-18, an exemplary reconfigurable patient bed 100 includes four repositionable bed sections 102, 104, 106, 108 mounted to a portable chassis 110. Each of the bed sections 102, 104, 106, 108 is independently repositionable with respect to the other bed sections, but each section may be repositioned in concert with other bed sections to change the orientation of a patient. In exemplary form, the patient bed 100 is reconfigurable from a relatively flat position (see FIG. 14), to a seating position (see FIG. 16), to a distal raised position (see FIG. 17), to a proximal raised position (see FIG. 15), and combinations in between. The independently repositionable bed sections 102, 104, 106, 108 provide a plethora of alternative lying positions, as well as the opportunity to reconfigure the bed 100 into an excrement receiver position (see FIG. 20). This is particularly useful for patients that are unable or unwilling to exit the bed to discharge bodily waste, as well as those requiring special needs to exit the bed.

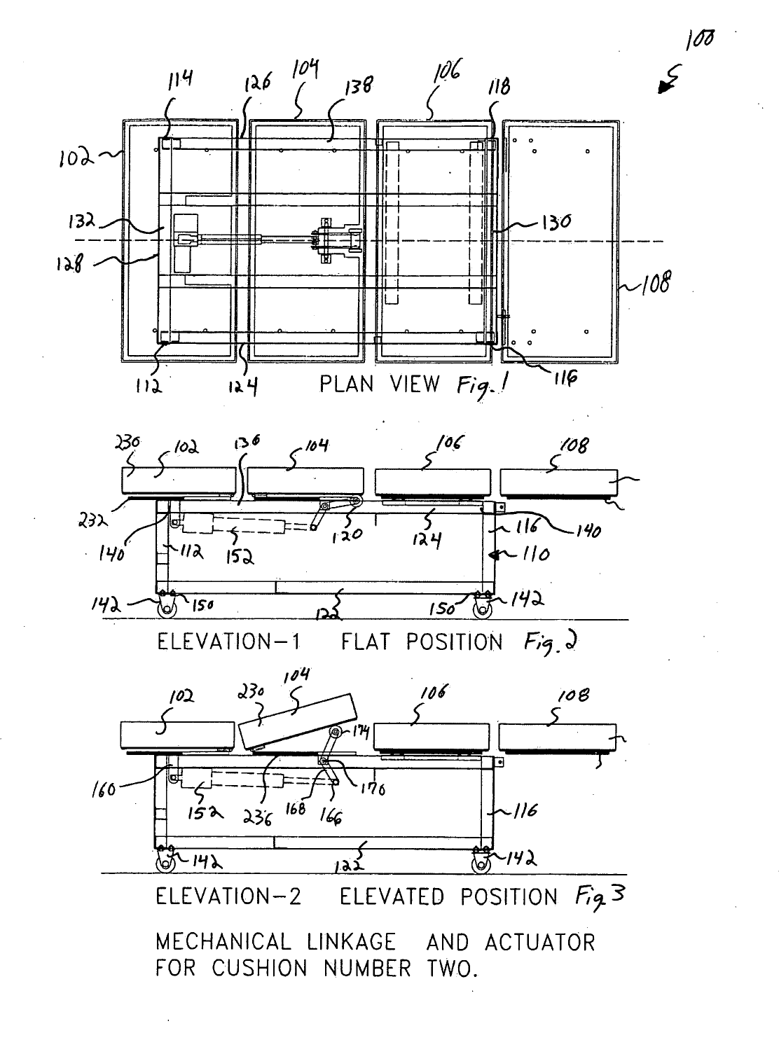

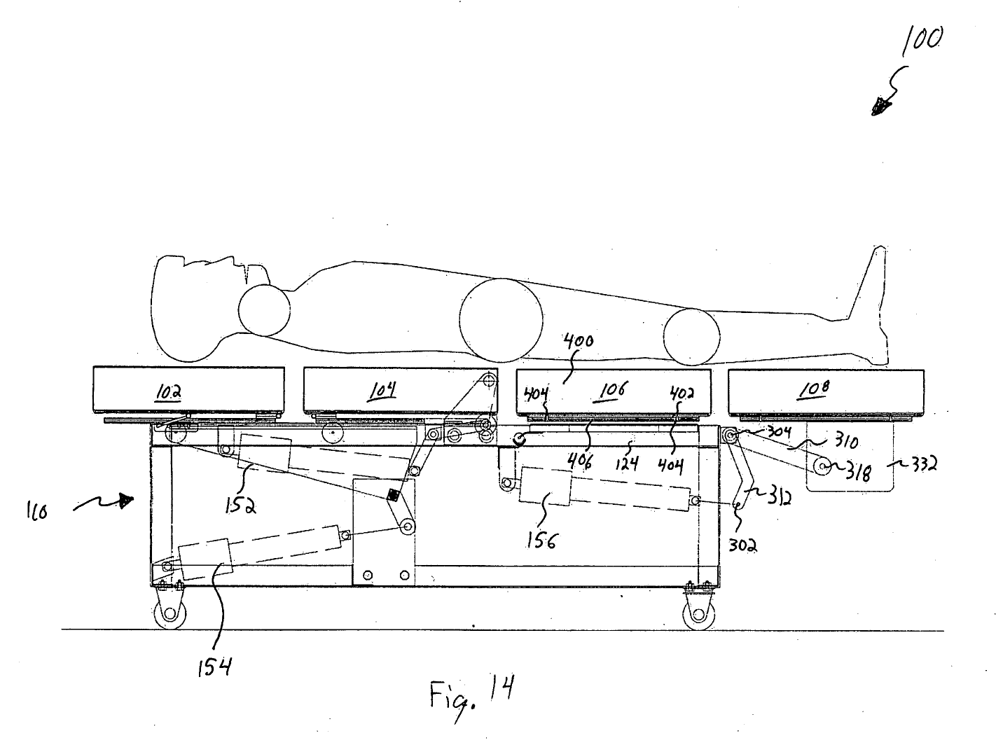

Referring to FIGS. 1 and 2, an exemplary portable chassis 110 includes four vertical supports 112, 114, 116, 118 connecting an upper and lower rectangular frames 120, 122 to one another. Each frame 120, 122 includes a pair of longitudinal rails 124, 126 equidistantly spaced apart and indirectly mounted to one another at their respective ends by a pair of terminal cross-member 128, 130. In this exemplary embodiment, the longitudinal rails 124, 126 comprise two inch (2″) angle iron having a first flange 132 oriented vertically upward and a second flange 134 (see FIG. 8) extending perpendicularly from the lower edge of the first flange 132 and oriented horizontally toward the interior of the frame 120, 122. The terminal cross members 128, 130 are also fabricated from two inch (2″) angle iron having one flange 136 oriented vertically upward and the other flange 138 extending perpendicularly from the lower edge of the first flange 136 and oriented horizontally toward the interior of the frame 120, 122. Each of the horizontal flanges 134, 138 of the rails 124, 126 and the cross-members 128, 130 include an angle cut at 45° at their respective ends to facilitate mounting the rails and cross members perpendicular to one another.

Assembly of the frames 120, 122 includes mounting the terminal cross-members 128, 130 to the rails 124, 126 by welding or using any commercially available fasteners such as, without limitation, bolts and nuts. In this exemplary embodiment, the ends of the terminal cross-members 128, 130 are abutted against the ends of the rails 124, 126 and oriented at right angles so that the terminal 45° cuts abut one another, thereby forming two rectangular frames 120, 122 having generally the same dimensions with the horizontal flanges all facing toward the interior of the frame. In this configuration, the vertical flanges 132, 136 are welded together at their seams, while the horizontal flanges 134, 138 are also welded along their seams.

Bolts and nuts may be utilized to mount the cross-members 128, 130 and the rails 124, 126 to one another where a 45° angle cut at the ends of the members and rails is omitted. In such a circumstance, the horizontal flanges at the ends of the cross-members 128, 130 lie upon the horizontal flanges at the ends of the rails 124, 126. In such a configuration, the flanges include through holes that accept one or more bolts or other fasteners. It should also be understood that the alternate circumstance, just as the primary circumstance, provides for the ends of the vertical flanges to abut one another.

After the frames 120, 122 have been assembled, the frames are oriented to overlap one another and are vertically spaced apart by a predetermined distance. In this exemplary embodiment, the predetermined distance is the approximate length of the vertical supports 112, 114, 116, 118, less the height of the vertical flange 132, 136 of each frame 120, 122. Each of the four vertical supports 112, 114, 116, 118 is oriented so that a corresponding corner of each frame 120, 122 is inset within the L-shaped notch of the two inch (2″) angle iron vertical supports so that the bottom of each support 112, 114, 116, 118 is substantially flush with the bottom of the vertical flange 132, 136 of the lower frame 120 and the tops of each support is substantially flush with the top of the vertical flange of the upper frame 122. In other words, the four vertical supports 112, 114, 116, 118 provide external caps for the corners of the frames 120, 122. After the supports are appropriately positioned to be adjacent to the corners of the frames 120, 122, each support 112, 114, 116, 118 is welded to the vertical flanges 132, 136 of each frame 120, 122 along its longitudinal edges 140. The resulting structure is a chassis 110 comprising two overlapping frames 120, 122 that are spaced apart.

While the frames 120, 122 are preferably welded together, it is also within the scope of the invention to utilize other fasteners to mounted the frames together by way of the vertical supports 112, 114, 116, 118. Exemplary fasteners include, without limitation, conventional nuts and bolts. Pursuant to the alternate circumstance of using nuts and bolts as fasteners, the 112, 114, 116, 118 and horizontal flanges are drilled or prefabricated to include hole that receive bolts or other fasteners. The fasteners are secured in place, resulting in the chassis 110 comprising two overlapping frames 120, 122 that are spaced apart.

The exemplary chassis 110 is rendered portable using four casters 142 mounted proximate each of the four corners of the lower frame 122. Each caster 142 is bolted to a caster frame, where the caster frame is welded to the longitudinal rail 124 and adjacent terminal cross-member 128 within the corners of the lower frame 122. The caster frame comprises two, one and one-half inch (1.5″), angle iron frame members of substantially the same length and tapered at 45° angles at opposing ends along the horizontal flange. The frame members are abutted against one another to form a right angle and welded to one another along the horizontal and vertical seams. The frame members are then positioned in the corners of the lower frame 122 so that the exposed ends of the frame members abut the vertical flanges 132, 136 of one of the rails 124, 126 and an adjacent cross-member 128, 130. Moreover, the frame members sit on top of the horizontal flanges 134, 138 of these same rails 124, 126 and cross-members 128, 130. The ends of the frame members adjacent to the rail 124, 126 and cross-member 128 are welded to the rail and cross-member to form a rectangle in each corner of the frame 122. This rectangle approximate the corner includes four vertical flanges and four horizontal flanges that face one other. In this manner, a ledge is formed onto which a steel plate, slightly smaller, but approximate the dimensions of the rectangle, is positioned. The circumferential edges of the plate are welded to the frame members, rail 124, 126, and cross-member 128. The steel plate may have predrilled holes (not shown) to accept bolts 150 to secure the casters 142 thereto, or the holes may alternatively be drilled subsequent to the plate being mounted to the circumferential ledge of the caster frame. In either instance, bolts 150 are inserted through the holes in the plate and secured by corresponding nuts to mount the casters 142 to the caster frame. In this exemplary embodiment, the casters 142 are one piece rigid casters, but it is also within the scope of the invention to use swivel casters, brake-assisted casters, and/or composite casters.

Referencing FIGS. 14-18, the exemplary chassis 110 has mounted to it three linear actuators 152, 154, 156 that are operative to change the orientation of the bed sections 102, 104, 108. In this exemplary embodiment, the linear actuators 152, 154, 156 are electrically powered, whether through a local battery (i.e., a direct current source) or through an alternating current outlet, and are operative to extend and retract a piston along the length of a hollow cylinder. Those skilled in the art are familiar with linear actuators and also familiar with the controls associated with linear actuators to reposition the piston with respect to the cylinder between an extended position and a retracted position. In exemplary form, linear actuators include a piston that provides linear motion via a motor driven ball screw, lead screw, or ACME screw assembly. For purposes of brevity, a detailed explanation of the operation of linear actuators has been omitted. Exemplary linear actuators for use with the instant invention include AC/DC linear actuators available from Joyce/Dayton Corporation (www.joycedayton.com). It is also within the scope of the invention to utilize pneumatic or hydraulic actuators in lieu of the linear actuators.

While not shown, it is also within the scope of the invention to utilize another linear actuator mounted to a proximal end of the chassis to raise and lower this end of the chassis. This linear actuator may be mounted to proximal terminal cross-member 128 of the upper frame 122. A first end of the actuator is mounted to a frame clevis centered along the cross-member 128. The frame clevis is welded to the cross-member 128 and includes opposing holes adapted to receive a bolt that concurrently pierces holes (not shown) within a mounting bracket associated with the actuator. In this manner, one end of the actuator is mounted to the terminal cross-member 128 of the upper frame 122, while an opposing end of the actuator (i.e., the piston end) is mounted to a repositionable stand (not shown). Accordingly, such an actuator is operative to provide various degrees of tilting of the entire chassis 110.

In this exemplary embodiment, the repositionable stand includes a pair of lateral legs connected to one another by an adjoining section. The stand generally has a block U-shape with the opposing legs being pivotally mounted to the longitudinal rails 124, 126 of the lower frame 122. Both of the legs and the adjoining section of the stand are fabricated from three inch (3″) angle iron sections welded together. Each leg includes at least one through hole (not shown) adapted to overlap with a through hole of a corresponding rail 124, 126 and concurrently receive a bolt to mount the legs (i.e., the stand) to the chassis 110. In this exemplary embodiment, the adjoining section has mounted to it a clevis, approximately centered, that is adapted to receive a bolt that likewise pierces a hole (not shown) through the piston to mount the rod to the stand.

In operation, when the piston of the actuator is fully retracted, the stand is lifted off the ground so that the casters 142 support the full weight of the chassis 110. In other words, presuming the casters 142 are located on a level surface, the position of the piston at its fully retracted position does not disturb this the level orientation of the chassis 110. If it is desired to tilt the chassis 110 to have an incline from front to back, the piston is extended to direct the stand toward the floor. Continued extension of the piston, after the stand contacts the floor, lifts the two proximal casters 142 and proximal aspect of the chassis 110 off of the ground with ever increasing height until reaching maximum extension, corresponding approximately to a 35° angle between the floor and longitudinal rails 124, 126. Depending upon the degree of incline desired, the legs may be altered (or the longitudinal rails 124, 126 altered) to increase or decrease the incline angle. Moreover, the actuator itself may be exchanged for another actuator having a greater extension length. Likewise, the holes through the rails 124, 126 and legs may be repositioned to increase or decrease the incline angle as a function of displacement of the piston. Because the actuator is electronically controlled, the precise amount of extension of the piston may be set to achieve the angle of incline desired. When a particular incline is no longer preferred, the piston is simply refracted or further extended (presuming the piston is not already at maximum extension), using an associated electronic control (not shown), to reposition the stand to decrease, increase, or eliminate the incline. Adjustment of the incline using the electronic control may be repeated numerous times to go between a horizontal and inclined positions and vice versa.

Referring again to FIGS. 1-3 and 14-18, another linear actuator 152 is mounted to a back frame 144 in order to provide a tilting feature for the second bed section 104. Specifically, a proximal end of the second bed section 104 is pivotally mounted to the back frame 144, which is itself indirectly pivotally mounted to the longitudinal rails 124, 126, thereby allowing the distal end of the bed section 104 to be raised and lowered with respect to the rails 124, 126 and back frame 144. One end of the second linear actuator 152 is pivotally mounted to a support structure 160 of the back frame, while an opposing end of the actuator is mounted to a pivoting mechanism 164. The support structure 160 includes a clevis 162 welded to a support plate, that is itself mounted to the back frame 144. The clevis 162 is adapted to accept a pin 164 piercing an end of the actuator 152 to securely fasten this same end of the actuator to the back frame 144. An opposing end of the second linear actuator 152 includes the piston end, which has an opening therethrough. This opening is adapted to receive an axel 166 that is concurrently received within corresponding openings within a pair of spaced apart, L-shaped pieces 168. At the base of each L-shaped piece 168 is a through hole that accept another axel 170. This axel 170 concurrent pierces these openings, as well as corresponding openings through a pair of angle brackets 172 that are mounted to the underside of the back frame 144. Each end of each L-shaped piece 168 has mounted to it a roller 174 that is adapted to engaged the underside of the second bed section proximate a distal end.

Operation of the linear actuator 152 allows for raising and lowering the distal end of the second bed section 104. Specifically, the actuator may be repositioned between a fully retracted position and a fully extended position (see FIG. 3). In its fully retracted position, the rollers 174 are recessed below the underside of the second bed section 104. As the actuator 152 is engaged to extend the piston, the piston operates to reposition both L-shaped pieces 168 so each pivots about the axel 170. The pivoting motion is operative to bring the rollers 174 into engagement with the underside of the second bed section 104 (see FIG. 14). Continued extension of the piston further pivots the L-shaped pieces 168 so the rollers contact and roll on the underside of the second bed section 104. Because the proximal portion of the second bed section 104 is pivotally mounted to the back frame 144, the upward pressure applied by the rollers 174 results in pivoting movement of the second bed section 104. Eventually, the piston of the actuator 152 reaches its point of maximum extension, also corresponding to a maximum incline of the second bed section 104 (see FIG. 17). Obviously, the electronic controls of the actuator 152 allow for repositioning of the piston at various points between its fully retracted position and fully extended position, which allow for various degrees of incline of the second bed section: Those skilled in the art will also understand that the electronic controls of the actuator 152 may comprise an individual control, or may be integrated in to a master control for controlling two or more actuators simultaneously or sequentially.

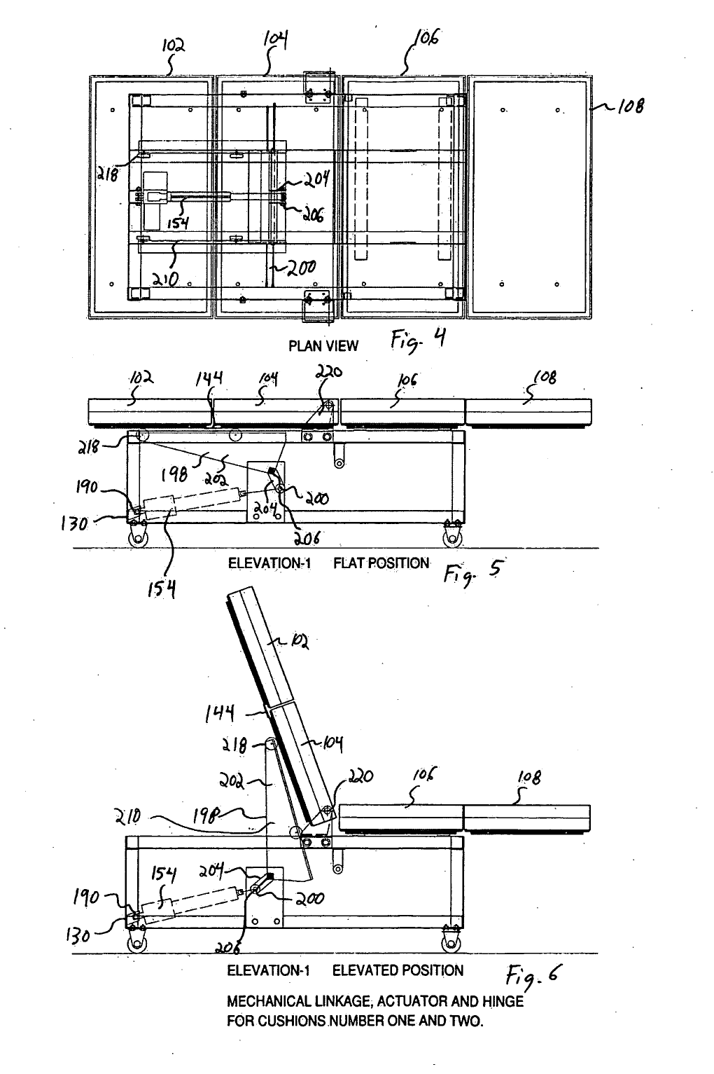

Referring to FIGS. 4-6 and 14-18, a further linear actuator 154 is mounted to the vertical flange 136 of the terminal cross-member 130 on the inside of the lower frame 120 nearest the first bed section 102. A first end of the actuator 154 is mounted the cross-member 130 by way of a frame clevis 190 approximately centered along the cross-member 128 of the lower frame 120. The frame clevis 190 is welded to the cross-member 128 and includes opposing holes (not shown) adapted to receive a bolt that concurrently pierces holes within amounting bracket associated with the second actuator 154. In this manner, one end of the actuator 154 is mounted to the lower frame 120, while an opposing end of the actuator 154 (i.e., the piston is mounted to a repositionable lift 198.

In this exemplary embodiment, the repositionable lift 198 includes an axel 200 that extends approximately the width of the chassis 110 and is pivotally mounted to a pair of upstanding plates 202 mounted to, and extending vertically from, the longitudinal rails 124, 126 of the lower frame 120. Each plate 202 includes a pair of holes (not shown) to receive respective ends of the axel 200. A slanted clevis 204 is mounted to the axel 200 and positioned approximate its midpoint. This slanted clevis 204 extends beneath the axel 200 in a direction away from the second linear actuator 154. In order to mount the slanted clevis 204 to the piston end of the actuator 154, a bolt 206 concurrently pierces a hole (not shown) through the end of the piston and the holes of the slanted clevis 206. In this manner, extension or contraction of the piston of the actuator 154 is operative to rotate the axel 200 in either a clockwise or counterclockwise direction with respect to the chassis 110. This rotation is ultimately transformed into rotational motion (i.e., up or down motion) of the first and second bed sections 102, 104 by way of the repositionable lift 198 engaging the back frame 144.

The repositionable lift 198 also includes a wheeled undercarriage 210 that engages the underside of the back frame 144. The wheeled undercarriage 210 comprises a pair of generally triangular plates 202 and tied together by welded cross-supports. A corner of each of the triangular plates 202 is welded to the axel 200 so that rotation of the axel 200 corresponds to rotation of the wheeled undercarriage 210. A series of rollers 218 are mounted to the triangular plates and engage the underside of the back frame 144 to convert the rotation of the axel 200 into pivotal movement of the back frame 144. Those skilled in the art will readily understand that various rollers 218 may be used with the present invention such as, without limitation, garage door rollers. Because the repositionable lift 198 and back frame 144 have pivot points that are not coaxial, the rollers 218 of the undercarriage 210 allow the undercarriage to slide with respect to the back plate 144.

The back plate 144 comprises a 0.25″ sheet of aluminum that is mounted to a pair of pivoting brackets 220 mounted to the longitudinal rails 124, 126 of the upper frame 120. In exemplary form, each pivoting bracket 220 comprises a pair of L-shaped brackets. A first L-shaped bracket is mounted to the back plate 144 and extends laterally outward from the second bed section 104. This first L-shaped bracket is inset within the second L-shaped bracket so that a hole through each L-shaped bracket receives a bolt enabling the brackets to pivot with respect to one another. The second L-shaped bracket is mounted to a longitudinal rail to laterally extend outward, away from the second bed section 104. Essentially, the bolt provides the pivot point for the back plate 144 with respect to the chassis 110.

Referring to FIGS. 1-6 and 14-18, each of the first two bed sections 102, 104 includes an removable universal cushion 230 mounted to a plywood backer 232, which is mounted to the back plate 144. Each cushion 230 is preferably resistant to liquid diffusion and also includes an outer cover that may be readily removed and laundered. In this exemplary embodiment, each cushion 230 is mounted to the plywood backer 232 using hook and pile strips (i.e., Velcro), but it should be understood that other fasteners such as, without limitation, straps and adhesives may be utilized in addition to or in lieu of hook and pile strips. The second bed section 104 is somewhat different than the first bed section 102 in that this second bed section includes a second plywood backer 236 (see FIG. 3) that is pivotally mounted to the first backer 232 by way of a series of hinges mounted proximate adjacent edges of the backers 232, 236. As will be apparent to those skilled in the art, this dual backer arrangement is important because it allows the second bed cushion 230 to be inclined independently from the other bed cushions.

Referencing FIGS. 4-6 and 14-16, when the piston of this actuator 154 is fully retracted, the lift 198 is in its fully upright position (see FIG. 16) so that the first and second bed sections 102, 104 are in a substantially vertical position (i.e., generally greater than 70°, where 90° would be perpendicular to the horizontal plane). As the piston is extended from its fully retracted position, it pushes against the slanted clevis 204 to cause the axel 200 to rotate with respect to the chassis 110. This rotation of the axel 200 coincides with rotation of the undercarriage 210, thereby causing the bed sections 102, 104 to correspondingly decline. Specifically, as the undercarriage 210 is rotated, the rollers 218 traverse along the back frame 144 to maintain contact between the undercarriage and the bed sections 102, 104. In this manner, the undercarriage 210 is laterally repositioned with respect to the bed sections 102, 104. This lateral repositioning between the bed sections 102, 104 and the undercarriage 210 is a necessary result of the sections not having the same point of rotation as the axel 200. As discussed above, the bed sections pivot around the brackets 220. Continued movement of the piston of the actuator 154 toward its fully extended position continues to reposition the undercarriage 210, thereby decreasing the incline of the bed sections 102, 104 until the bed sections come to rest in their horizontal position with each section sitting upon the flanges 132, 136 of the upper frame 120. In contrast, the piston of the actuator 154 may be retracted to provide various degrees of incline (presuming the piston is not in its fully retracted position). In this exemplary embodiment, as explained above, the actuator 154 is electronically controlled to provide the sections 102, 104 with a plethora of incline adjustments between a horizontal position and a fully elevated position.

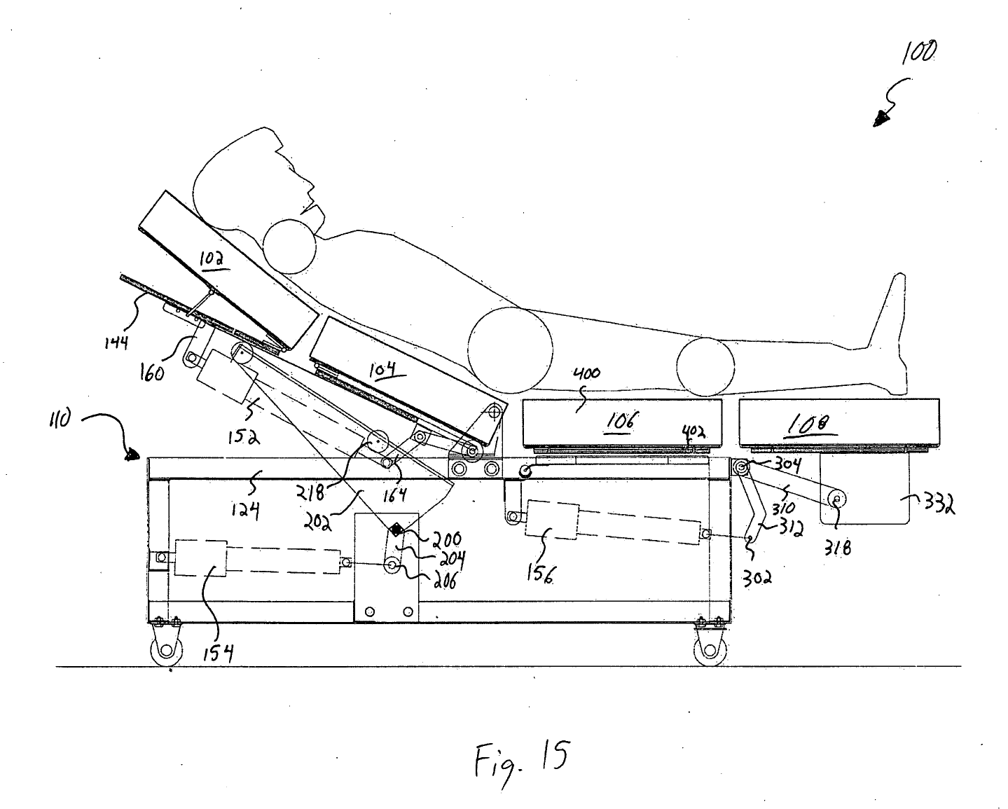

Referring to FIGS. 10-18, a further actuator 156 located beneath the third bed section 106 and extends generally between and in parallel with the rails 124, 126 of the upper frame 120. A first end of the actuator 156 is mounted to a clevis 262 approximately centered on a beam 260 that is mounted to the underside of the rails 124, 126 and is oriented perpendicular to the rails. The clevis 262 receives a bolt that also pierces a mounting hole of the actuator 156, thereby mounting the actuator to the clevis and beam, while also allowing the actuator to pivot with respect to the clevis as the piston of the actuator is retracted and extended. In this exemplary embodiment, the beam 260 is fabricated from 3″ angle iron, where a first flange is oriented perpendicularly and abuts the underside of the rails, while a second flange is oriented vertically, so that the interior of the beam faces toward the distal portion of the bed. While various forms of fasteners, such as nuts and bolts may be utilized to mount the clevis 262 and beam 260 to the upper frame 120, in this exemplary embodiment, the clevis is welded to the beam, which is welded to the upper frame.

An opposite end of the actuator 156, the actuator piston, is mounted to a repositioning mechanism 300 for the fourth bed section 108. In exemplary form, the repositioning mechanism 300 includes a pair of axels 302, 304 mounted to a primary lift linkage that is attached to the underside of the fourth bed section 108. In this exemplary embodiment, the fourth bed section 108 includes an individual cushion 306 mounted to a plywood backer 308, where the plywood backer may be optionally mounted to an aluminum backer (not shown) opposite the cushion. The cushion 306 is preferably resistant to liquid diffusion and also includes an outer cover that may be readily removed and laundered. In this exemplary embodiment, the cushion 306 is mounted to the plywood backer 308 using hook and pile strips (i.e., Velcro), but it should be understood that other fasteners such as, without limitation, straps and adhesives may be utilized in addition to or in lieu of hook and pile strips.

A first of the axels 302 is received via a hole through the end of the piston of the actuator 156 to allow the axel to rotate with respect to the end of the piston. This first axel 302 also is received by a pair of substantially linear guide plates 312 that are welded to the, second axel 304. This second axel 304 is received within a pair of holes of a clevis 314 mounted to the distal terminal cross-member 130 of the upper frame 120. Specifically, the clevis 314 is generally centered, from side to side, and mounted to the outside of the vertical flange 136 (i.e., away from the first bed section 102) by way of fasteners or by welding. The second axel 304 is operative to rotate with respect to the stationary clevis 314 based upon inward or outward movement of the piston of the actuator 156. Effectively, the second axel 304, guide plates 312, and clevis 314 cooperate to ensure movement of the piston of the actuator 156 is appropriately transferred to a pair of substantially linear lift arms 310. Each of the lift arms is mounted to an axel 302, 318, by way of a pair of opposing holes formed proximate the ends of the arms. These holes allow the axels 302, 318 to rotate with respect to the arms 310. The far end of the arms 310 is mounted to the axel 318 that is received within a clevis 320 mounted to the underside of the fourth bed section 108. As discussed above, the clevis may be mounted to one or both of the plywood backer 308 and the aluminum backer. In this exemplary embodiment, the guide plates 312 and lift arms 310 are fabricated from 0.25″ bar stock, while the axels 302, 304, 318 are fabricated from ⅜″ diameter solid metal cylinders. As will be discussed in more detail hereafter, the lift arms 310 and guide plates 312 may have multiple holes formed therethrough to provide for adjustability with respect to the lift height and responsiveness of lift of the fourth bed section 108 based upon movement of the piston of the actuator 156. But the primary lift linkage is supplemented with a secondary linkage mounted on one or both sides of the primary lift linkage.

The secondary linkage includes an adjustable plate 332 mounted to the underside of the fourth bed section 108. The adjustable plate 332 is fabricated from ⅛″ metal plate and includes numerous holes to accommodate multiple fastener positions that may be utilized to for adjustability with respect to the lift height and responsiveness of lift based upon movement of the piston of the actuator 156. A pair of linkage arms 334, 336 are mounted to the plate 332 on opposing sides using standard nut and bolt fasteners that allow rotation of the bolts with respect to the plate 332 and linkage arms 334, 336. In this exemplary embodiment, the linkage arms 334, 336 comprise ⅛″ bar stock. The first linkage arm 334 is also welded to an axel 338 that is received within a pair of holes of a clevis 340 mounted to the distal terminal cross-member 130 of the upper frame 120. Specifically, the clevis 340 is generally centered, between the clevis 314 of the primary lift linkage and the nearest corner of the upper frame 120, and mounted to the outside of the vertical flange 136 (i.e., away from the first bed section 102) by way of fasteners or by welding.

The second linkage arm 336 comprises a primary arm and a secondary arm pivotally mounted to one another, where the secondary arm is pivotally mounted to the plate 332 using a standard nut and bolt that allow for rotation of the bolt. The primary arm is pivotally mounted to a downwardly extending bracket 342 mounted to the underside of the horizontal flange 138 of the distal terminal cross-member 130 of the upper frame 120.

The secondary linkage further includes a tracking arm (not shown) pivotally mounted to the underside of the fourth bed section 108 at one end, while a second end is pivotally mounted to a swing arm (not shown). The swing arm is also pivotally mounted to the first linkage arm 334 so that movement of the first linkage arm is tracked by the tracking arm. One end of a spring (not shown) is attached proximate the pivot point between the swing arm and the tracking arm, while an opposing end of the spring is mounted to the upper frame 120.

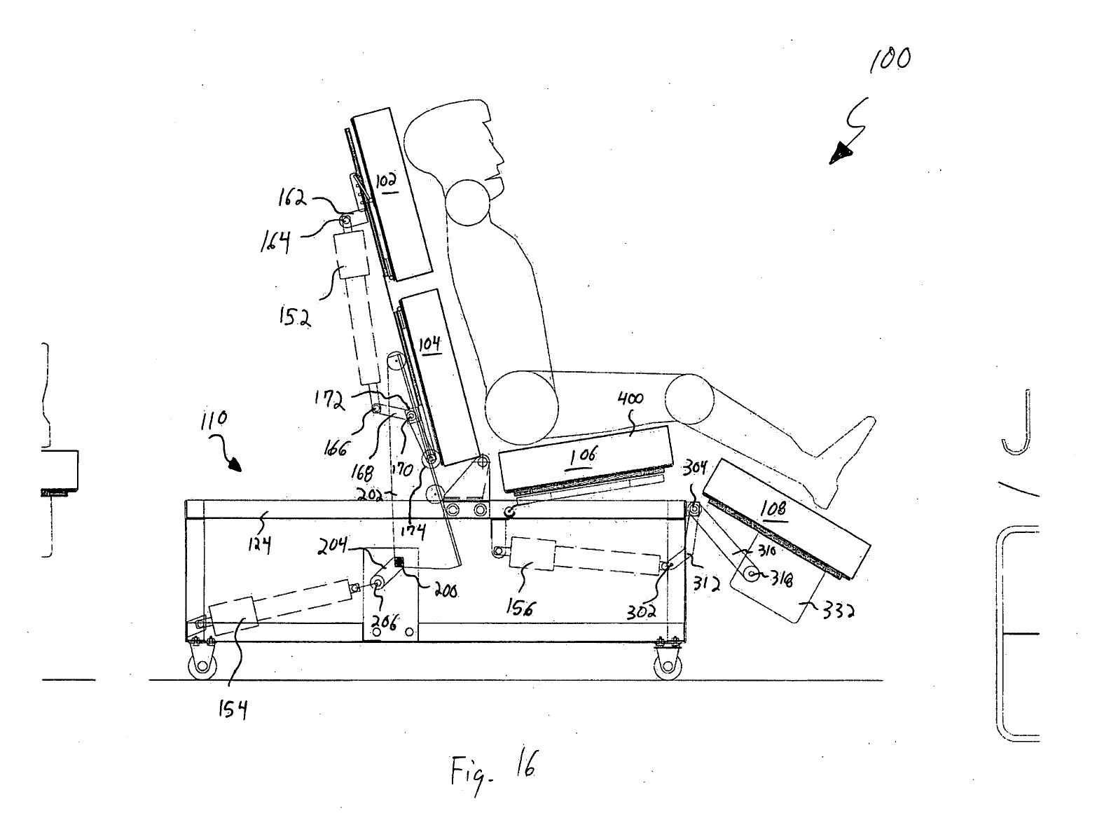

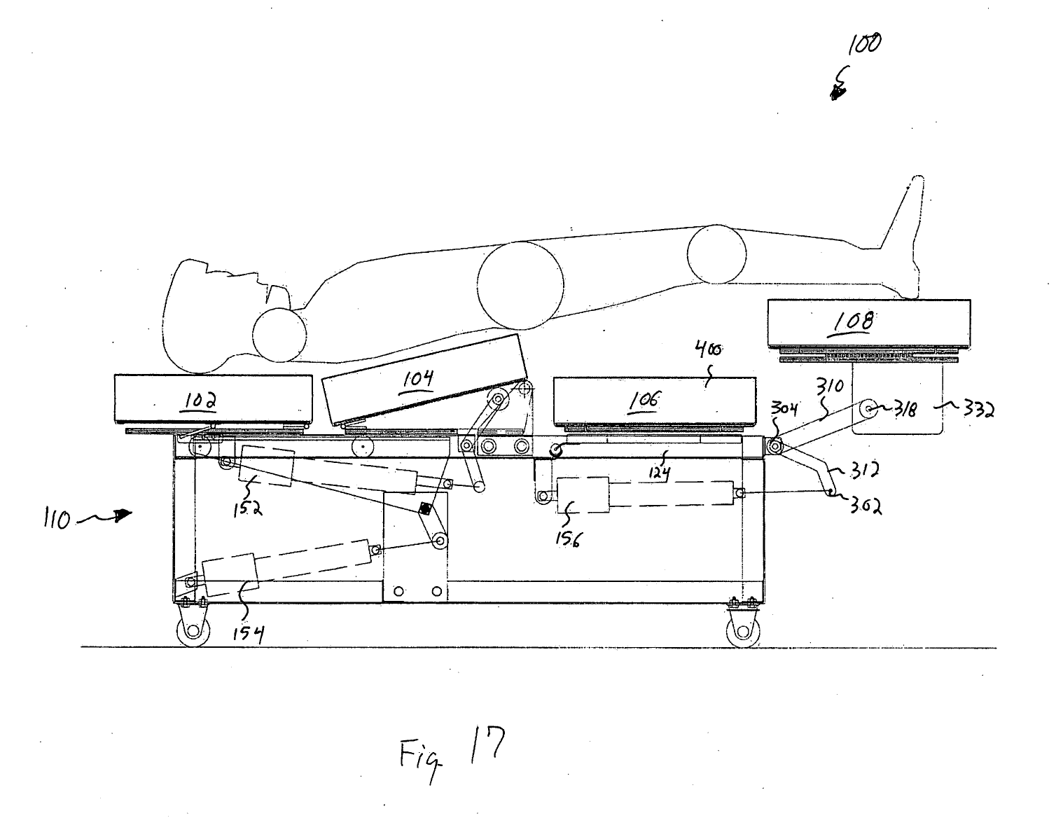

In operation, extension or retraction of the piston of the actuator 156 is operative to raise or lower the fourth bed section 108. In exemplary form, extension of the actuator 156 piston from its fully retracted position is operative to reposition the fourth bed section 108 from its fully lowered position (see FIG. 13). Extension of the piston from its fully retracted position is operative to cause the guide plates 312 to rotate, about the pivot point proximate the distal cross-member of the upper frame 120, from a fully retracted position (see FIG. 13) to a multitude of raised positions (see FIGS. 11 and 12). At the same time, the extension of the piston is operative to raise the lift arms 310, thereby raising the fourth bed section from a fully lowered position (see FIG. 13) to a multitude of raised positions (see FIGS. 11 and 12). Concurrent with movement of the guide plates 312 and lift arms 310, portions of the secondary linkage are also repositioned. Specifically, the linkage arms 334 and tracking arm. In so doing, the lateral stability of the fourth bed section 108 is supplemented by the secondary linkage.

As can be seen comparing FIGS. 11-13 with one another, when the actuator 156 piston is fully retracted, the fourth bed section 108 is angled downwardly and positioned below the other bed sections 102, 104, 106. Initial extension of the actuator 156 piston is operative to tilt the fourth bed section 108 to provide a substantially planar position where the fourth bed section 108 is substantially level with the remaining bed sections 102, 104, 106, presuming the other bed sections are flat. Further extension of the actuator 156 piston is operative to raise the fourth bed section 108 above the other bed sections so that the fourth bed section remains substantially level. As those skilled in the art will understand after review of the instant disclosure, multiple positions between those shown in FIGS. 11-13 are possible, particularly when using an electronic actuator.

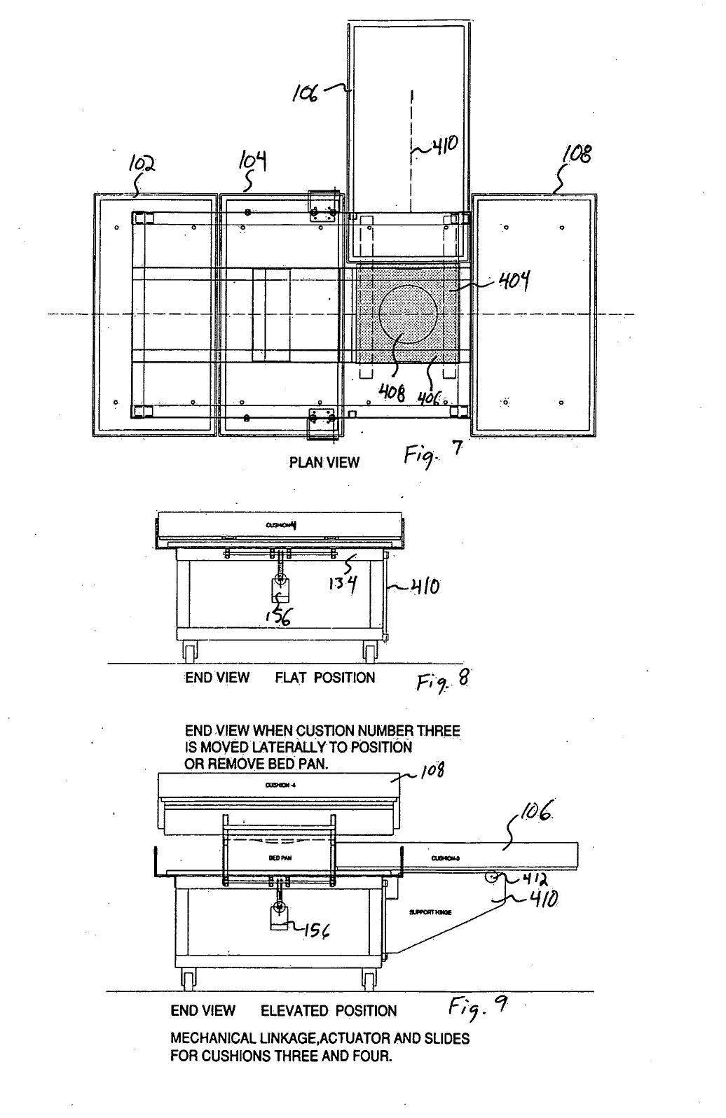

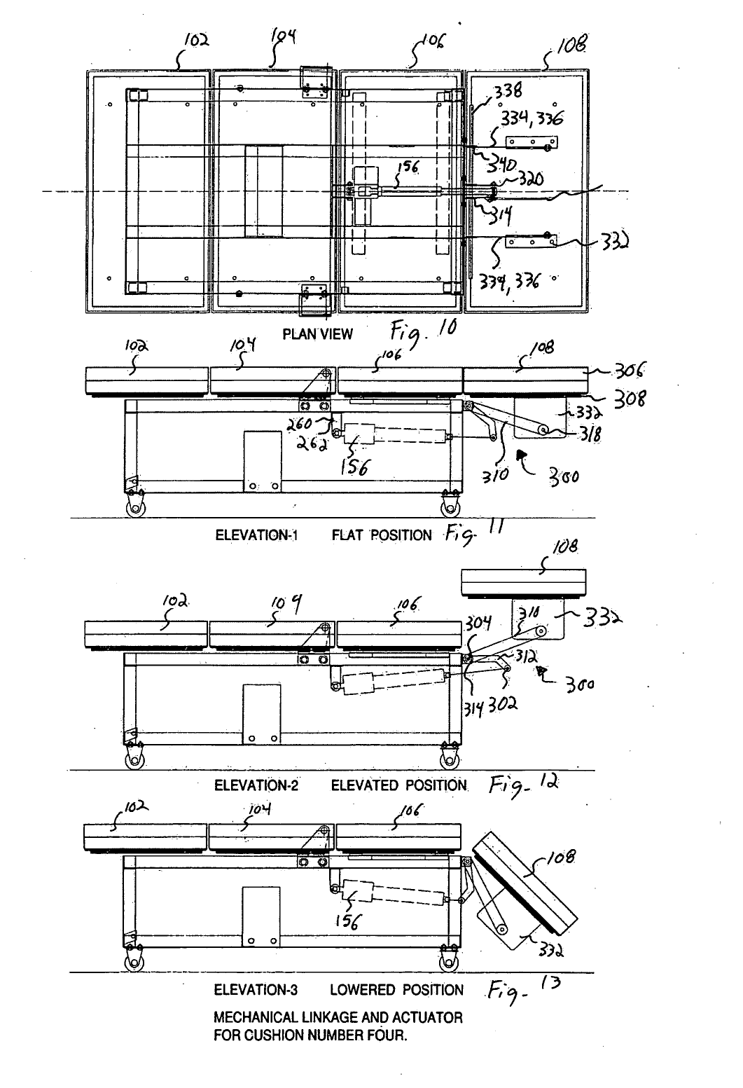

Referring to FIGS. 7-9 and 14-20, the third bed section 106 includes an individual cushion 400 mounted to a plywood backer 402. This cushion 400 is preferably resistant to liquid diffusion and also includes an outer cover that may be readily laundered. In this exemplary embodiment, the plywood backer 402 includes complimentary halves of a pair of slides 404, but with the other complementary slide halves being mounted to a plywood sheet 406 mounted on top of the upper frame 120. The plywood sheet 406 mounted on top of the chassis 110 includes a hole 408 in the center that is adapted to align with a removable defecation container (not shown) and/or a toilet seat 440 to allow bedridden patients access to a simulated toilet. In order to gain access to the hole 408 and defecation container, the third cushion 400 is slid laterally with respect to the plywood sheet 406 using the slides 404 to offset the cushion from the hole 408 (see FIGS. 7 and 9). Concurrent with this movement of the third cushion, or before, a lateral wing 410 pivotally mounted to the side of the chassis 110 is pivoted to a perpendicular position so that the third cushion 400 contacts a roller 412 on top of the wing, thereby supporting the weight of the cushion 400. After the patient has used the simulated toilet, the third cushion 400 may be laterally slid back into position (i.e., generally aligned with the other cushions) using the slides 404, as well as pivoting the wing 410 to a parallel position with respect to the chassis.

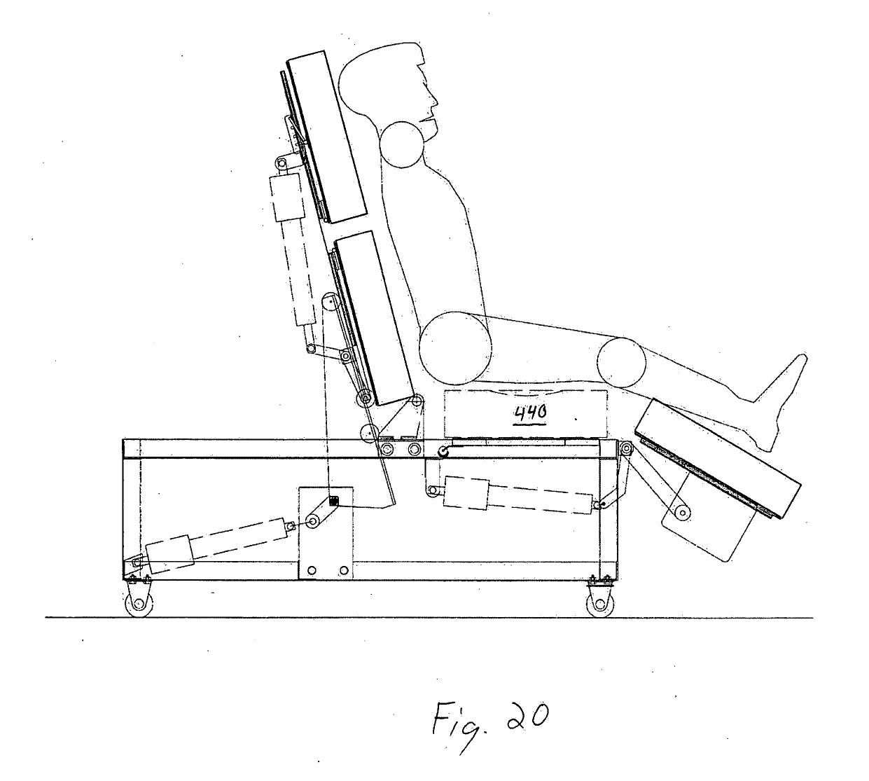

In order to utilize the simulated toilet, actuators 152, 154, 156 are utilized to reposition the bed sections and patient. In exemplary fashion, presuming the patient is initially lying down as shown in FIG. 14, the first and third actuators 152, 156 are operated to reposition the patient so the third bed section may be laterally slid out from under the patient and possibly removed. It is to be understood that movement of the actuators 152, 156 can occur alternatively or at the same time. First, the first actuator 152 is operated to extend the piston to increase the tilt of the distal end of the second bed section 104, thereby raising the lower torso of the patient. Second, the third actuator 156 is operated to extend the piston to increase the height of the fourth bed section 108, thereby raising the legs of the patient. Using the cooperative movement of the actuators 152, 156, the patient is raised above the third bed section 106 so that the bed section may be laterally slid from under the patient with minimal effort. After the third bed section 106 is removed from under the patient, the hole 408 through the plywood sheet 406 is exposed and may be utilized to align the simulated toilet 440 in position (see FIG. 19). After the simulated toilet 440 is in position, the actuators 152, 154, 156 may be operated to lower the lower torso of the patient, lower the patient's legs, and bring the torso into a generally upright position as shown in FIG. 20. As can be seen in FIG. 20, movement to the excrement receiver position includes retracting the pistons of all of the actuators 152, 154, 156. This process of repositioning me actuators and bed sections may be repeated in reverse order to arrive at the horizontal bedding position of FIG. 14.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations of elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A reconfigurable bed comprising:
a bed chassis;
a first bed section mounted to the bed chassis;
a second bed section mounted to the bed chassis;
a third bed section mounted to the bed chassis;
a fourth bed section mounted to the bed chassis;
a first actuator operatively coupled to the first bed section;
a second actuator operatively coupled to the bed chassis and operatively coupled to the second bed section; and
a third actuator operatively coupled to the bed chassis and operatively coupled to the third bed section;
where the first bed section, the second bed section, the third bed section, and the fourth bed section are oriented along a single plane to comprise a patient bed.

2. The reconfigurable bed of claim 1, wherein at least one of the first actuator, the second actuator, and the third actuator comprises at least one of a pneumatic actuator, a geared actuator, and a hydraulic actuator.

3. The reconfigurable bed of claim 1, wherein at least one of the first bed section, the second bed section, and the third bed section include a removable bed cushion, where the removable bed cushion for the first bed section is interchangeable with the removable bed cushion of the second bed section.

4. The reconfigurable bed of claim 1, wherein the fourth bed section is repositionable with respect to the first bed section, the second bed section, and the third bed section to selectively expose and cover an opening through the bed chassis.

5. The reconfigurable bed of claim 4, wherein the opening through the bed chassis is defined by a stationary platform upon which the third bed section rides to selectively expose and cover the opening through the bed chassis.

6. The reconfigurable bed of claim, 1, wherein the third bed section is independently repositionable with respect to the first bed section, the second bed section, and the third bed section in height and tilt.

7. The reconfigurable bed of claim 1, wherein:
the first bed section and the second bed section are mounted to a repositionable frame; and
the second actuator is operatively coupled to the repositionable frame to concurrently reposition the first bed section and the second bed section.

8. The reconfigurable bed of claim 7, wherein:
the first actuator is operatively coupled to the first bed section and operatively coupled to the repositionable frame; and
the first actuator is operative to reposition the first bed section independent of the second bed section.

9. The reconfigurable bed of claim 4, wherein the bed chassis includes a lateral fold-out stand operative to support the fourth bed section when the fourth bed section exposes the opening through the bed chassis.

10. A reconfigurable bed comprising:
a bed chassis;
a plurality of bed sections, each bed section including a removable universal bed cushion; and
a plurality of actuators operatively coupled the plurality of bed sections and operative to reposition at least one of the plurality of bed sections;
where at least one of the plurality of bed sections is laterally repositionable with respect to the bed chassis to expose an excrement receiver; and
wherein the laterally repositionable bed section interposes two of the plurality of bed sections, these two bed sections are adapted to be independently raised, thereby resulting in the laterally repositionable bed section being recessed with respect thereto and allow exposure of the excrement receiver.

11. The reconfigurable bed of claim 10, wherein:
the plurality of bed sections includes a first bed section;
the plurality of actuators includes a first actuator; and
the first actuator is operatively coupled to the first bed section and operative to change the tilt angle of the first bed section.

12. The reconfigurable bed of claim 11, wherein:
the plurality of bed sections includes a second bed section;
the plurality of actuators includes a second actuator; and
the second actuator is operatively coupled to the second bed section and the first bed section, the second actuator operative to change the height of the first bed section.

13. The reconfigurable bed of claim 10, wherein:
the plurality of bed sections includes a second bed section;
the plurality of actuators includes a second actuator; and
the second actuator is operatively coupled to the second bed section and operative to change the tilt angle of the second bed section.

14. The reconfigurable bed of claim 10, wherein at least one of the plurality of actuators comprises at least one of a pneumatic actuator, a geared actuator, and a hydraulic actuator.

15. The reconfigurable bed of claim 10, wherein at least three of the plurality of bed sections is operatively coupled to at least one of the plurality of actuators to reposition at least two of the at least three bed sections independently of one another.

16. The reconfigurable bed of claim 10, wherein:
at least two of the plurality of bed sections are concurrently mounted to a repositionable frame; and
at least one of the plurality of actuators is operatively coupled to the repositionable frame in order to concurrently reposition at least the two bed sections.

17. The reconfigurable bed of claim 10, wherein the bed chassis includes a lateral fold-out stand operative to support the laterally repositionable bed section when the laterally repositionable bed section exposes of the excrement receiver.

18. A method of reconfiguring a patient in a bed between a lying position and a seated position, the method comprising:
repositioning a first bed cushion and a third bed cushion, wherein a second bed cushion interposes the first bed cushion and the third bed cushion, wherein the first bed cushion and the second bed cushion are tilted so that at least a portion of the cushions are raised above the second bed cushion; and
repositioning the second bed cushion to expose ah opening of a simulated toilet while the first and third bed cushions are tilted.

19. The method of claim 18, wherein:
prior to repositioning the second bed cushion, the first bed cushion, the second bed cushion, and the third bed cushion lie along a single plane; and
subsequent to repositioning the second bed cushion, the first bed cushion, the second bed cushion, and the third bed cushion do not lie along the single plane.

20. The method of claim 18, further comprising the step of:
repositioning a first bed cushion to be approximately perpendicular with respect to a plane of the opening after repositioning the second bed cushion to expose the opening.
